(19) United States
(12) Patent Application Publication
(10) Pub. No.: US 2011/0177481 A1
(43) Pub. Date: Jul. 21, 2011

(54) ELECTRONIC DEVICE WITH MEDIA FUNCTION AND METHOD

(76) Inventors: Olle Háff, Malmo (SE); Anders Markstedt, Lund (SE); Samuel Sjöblom, Malmo (SE)

(21) Appl. No.: 12/687,927

(22) Filed: Jan. 15, 2010

(51) Int. Cl. G09B 5/00

(52) U.S. Cl. 434/317

(57) ABSTRACT

An electronic device switches between an electronic book reading mode and an audio book playback mode in a manner that is convenient and intuitive to the user. The electronic device stores an electronic work that contains a text version and an audio version of written material. The position in an active one of the text version or the audio version is matched against a corresponding position in the other one of the text version or the audio version. The user may indicate to the electronic device to switch modes. In that case, if the text version was active, playback of the audio version may commence from a point at which the user stopped reading the text version. Similarly, if the audio version was active, the text version may be displayed at the point where playback stopped.

### TECHNICAL FIELD OF THE INVENTION

The technology of the present disclosure relates generally to electronic devices and, more particularly, to a system and method for presenting media content to a user and switching between forms or versions of media content.

### BACKGROUND

Electronic books and electronic book reading devices are becoming more popular. An electronic book replaces a book that is printed on paper. The electronic book may be considered a data file that is stored on a memory (e.g., computer readable medium) and contains the text and any graphics of a written work (e.g., a novel, biography, non-fiction book, magazine, etc.) in electronic format. The electronic book may be read by a person by visually displaying the text on a display of an electronic book reading device. The electronic book reading device may be a device dedicated to the reading task or may include other functionality. For instance, an electronic book may be read on a mobile telephone.

Another popular format for written works is audio books. An audio book is a recording of one or more persons who have read a written work aloud. The audio book, therefore, may be considered a data file that is stored on a memory (e.g., computer readable medium) and contains data that when played back by a media player results in an audio signal corresponding to the written work.

Electronic books are difficult to use or are not possible to use in some situations. For instance, reading an electronic book while driving or walking would not be advisable and/or practical. While one may listen to an audio book in situations when reading may not be practical, a user may prefer the act of reading rather than listening in some circumstances. For instance, when riding in a train or a plane, or while relaxing at home or on vacation, a user may desire to read the text of a novel rather than listen to an audio performance of the novel.

### SUMMARY

To enhance user consumption of electronic media, the present disclosure describes an electronic device that has functionality to switch from a first media source to a second media source.

As an example, for written material, the present disclosure describes an electronic device that switches between an electronic book reading mode and an audio book playback mode in a manner that is convenient and intuitive to the user. In one embodiment, the electronic device stores an electronic work that contains a text version and an audio version of the written material (e.g., a fiction or non-fiction book). The position in an active one of the text version or the audio version is matched against a corresponding position in the other one of the text version or the audio version. The user may indicate to the electronic device to switch modes. In that case, if the text version was active, playback of the audio version may commence from a point at which the user stopped reading the text version. Similarly, if the audio version was active, the text version may be displayed at the point where playback stopped.

As another example, the user may read a document and come to a point where the document's author would like the user to watch a video starting from a point in the video selected by the author. In this case, the electronic device may switch from a reading mode to a video mode and play the video from the designated point in the video. At a subsequent designated point in the video, the electronic device may return to the reading mode at a designated point in the documents, such as the former point in the document at which the switch to the video mode was made.

According to an aspect of the disclosure, an electronic device has access to a first content item and a second content item, and includes at least one output for outputting content from the first and second content items to a user; and a processor configured to output content from the first content item; identify when user consumption of the first content item has reached a predetermined point in the first content item; and in response to the identification, switch to output content from the second content item starting at a predetermined point in the second content that is associated with the predetermined point in the first content item.

According to one embodiment of the electronic device, each of the first and second content items are one of text, audio, video or an Internet web page.

According to one embodiment of the electronic device, the predetermined point in the first content item and the predetermined point in the second content are marked with corresponding bookmarks.

According to one aspect of the disclosure, an electronic device includes a memory that stores an electronic work containing a text version of written material and an audio version of the written material; a display configured to display text from the text version in a reading mode; an audio output configured to output an audio signal corresponding to the audio version in a listening mode; and a processor configured to: in the reading mode, identify a user text position in the text version and, responsive to a user input to switch to the listening mode, switch to the listening mode and playback the audio version from a point that corresponds to the user text position; and in the listening mode, identify an audio playback position in the audio version and, responsive to a user input to switch to the reading mode, switch to the reading mode and display the text version from a point that corresponds to the audio playback position.

According to one embodiment of the electronic device, the audio output is one of a speaker, an input/output interface that is operatively connected to an accessory device having a speaker, or a wireless transceiver that is operatively connected to a wireless accessory device having a speaker.

According to one embodiment, the electronic device further includes a camera configured to capture video data of the user during the reading mode and the processor is further configured to analyze user eye gaze to identify the user text position.

According to one embodiment of the electronic device, a portion of displayed text is used for the user text position.

According to one embodiment of the electronic device, the processor converts at least a portion of the audio version to text, extracts text from the audio playback position, and searches the text version for corresponding text to identify the point in the text version that corresponds to the audio playback position.

According to one embodiment of the electronic device, the processor converts at least a portion of the audio version to text and searches the converted text for text that corresponds to text at the a user text position to identify the point in the audio version that corresponds to the user text position.

According to one embodiment of the electronic device, the text version and the audio version contain corresponding data markers used by the processor to identify the corresponding positions in the text and audio versions of the electronic work.

According to another aspect of the disclosure, a method of outputting written material to a user of an electronic device includes storing an electronic work in a memory, the electronic work containing a text version of written material and an audio version of the written material; in a reading mode of the electronic device: displaying text from the text version; identifying a user text position in the text version; and responsive to a user input to switch to a listening mode, switching to the listening mode and playing back the audio version from a point that corresponds to the user text position; and in the listening mode: playing back the audio version; identifying an audio playback position in the audio version; and responsive to a user input to switch to the reading mode, switching to the reading mode and displaying the text version from a point that corresponds to the audio playback position.

According to one embodiment, the method further includes capturing video data of the user during the reading mode and analyzing user eye gaze to identify the user text position.

According to one embodiment of the method, a portion of displayed text is used for the user text position.

According to one embodiment, the method further includes converting at least a portion of the audio version to text, extracting text from the audio playback position, and searching the text version for corresponding text to identify the point in the text version that corresponds to the audio playback position.

According to one embodiment, the method further includes converting at least a portion of the audio version to text and searching the converted text for text that corresponds to text at the a user text position to identify the point in the audio version that corresponds to the user text position.

According to one embodiment of the method, the text version and the audio version contain corresponding data markers used in the identifying of the corresponding positions in the text and audio version of the electronic work.

According to another aspect of the disclosure, a computer readable medium includes a first content item; a second content item; a first bookmark at a predetermined position in the first content item, the bookmark indicating to an electronic work function to switch from output of content from the first content item to output of content from the second content item; and a second bookmark at a predetermined position in the second content item, the second bookmark corresponding to the first bookmark and representing a predetermined starting point in the second content item at which the output of content from the second content item is to commence when user consumption of the first content item has reached the first bookmark.

According to an embodiment of the computer readable medium, each of the first and second content items are one of text, audio, video or an Internet web page.

According to another aspect of the disclosure, a computer readable medium stores an electronic work including a text version of written material; an audio version of the written material; position data markers in the text version; and position data markers in the audio version, each position data marker in the audio version corresponding to a data marker in the text version to identify corresponding positions in the text and audio versions of the electronic work.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a mobile telephone as an exemplary electronic device that includes an electronic work function in accordance with various aspects of the disclosure;

FIG. 2 is a schematic block diagram of the exemplary electronic device;

FIG. 3 is a flow chart representing an exemplary method of delivering media content to a user of the electronic device; and

FIG. 4 is a flow chart representing another exemplary method of delivering media content to a user of the electronic device.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a portable radio communications device, such as the illustrated mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, an electronic book reader, a media player, a gaming device, a computer, a pager, a communicator, an electronic organizer, a personal digital assistant (PDA), etc.

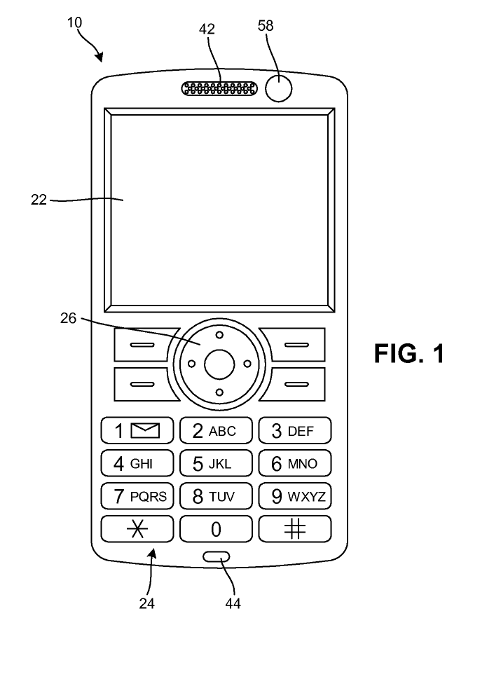

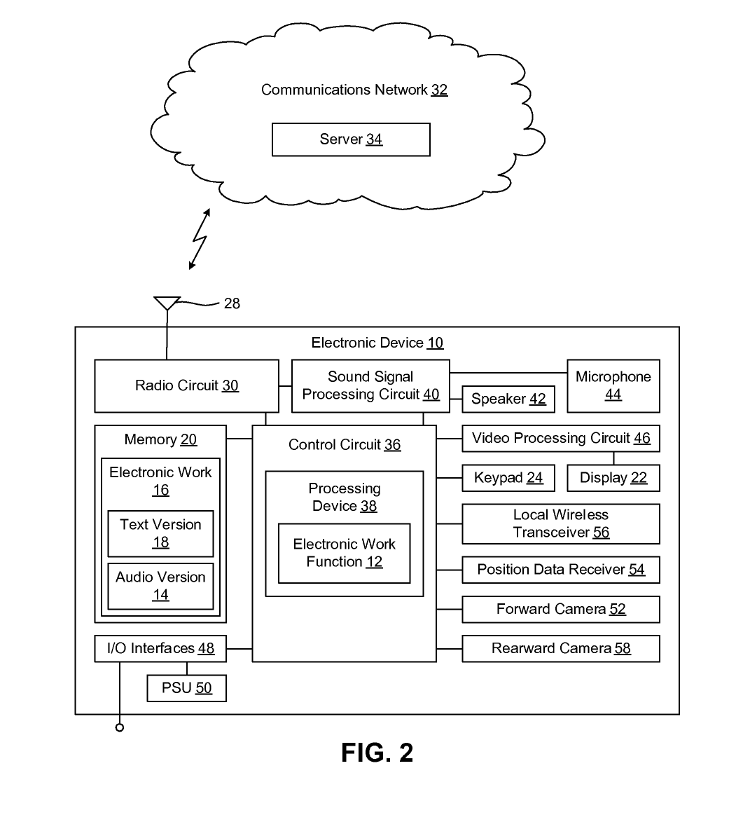

Referring initially to FIGS. 1 and 2, an electronic device 10 is shown. The electronic device 10 includes an electronic work function 12 that is configured to switch between playback of a first media source and playback of a second media source. For example, switching may be made between audio playback of an audio version of an electronic work 16 and display of a text version 18 of the electronic work 16. In this embodiment, the electronic work 16 also may be referred to as written material. It will be understood, however, that aspects of the disclosure are applicable to other media playback or content presentation scenarios, as will be described in greater detail.

The electronic work 16 may be in the form of one or more data files that are stored on a computer readable medium, such as the illustrated memory 20. In the case of written material, the electronic work 16 may be, for example a fiction book (e.g., a novel, a short story, etc.), a non-fiction book, a biography, a magazine article, a newspaper article or articles, or some other written document. The text version 18 may contain the written words of the electronic work in electronic form, plus electronic versions of any graphics, pictures or video that accompany the written words. The audio version 14 may contain a recording of one or more persons that have read the written words that appears in the electronic work. In another embodiment, the audio version 14 may be synthesized audio created by converting the text version 18 to speech with the electronic device 10 using text to speech software.

As another example, the electronic work 16 may have a video component in addition to or instead of one of the text version 18 or the audio version 14. In this case, the video component may be a version of the same written material (e.g., a video version or adaptation of an electronic book or an audio book), or the video component may be related to, but not the same as, the written material (e.g., a video with author commentary on the written work).

As yet another example, the electronic work 16 may include two or more media types. In this embodiment, the media types need not be corresponding versions of the same content. Also, the media types may be selected from a text document (e.g., the text version 18, a word processor document, an email, a text message, etc.), an audio file or a streaming audio source (e.g., the audio version 14, a music file, etc.), a video file or streaming video source, an Internet web page or a link to an Internet web page, or any other form of media or file.

Additional details and operation of the electronic work function 12 will be described in greater detail below. The electronic work function 12 may be embodied as executable instructions (also referred to as code, software, or a program) that is resident in and executed by the electronic device 10. In one embodiment, the electronic work function 12 may be one or more programs that are stored on a computer readable medium (e.g., the memory 20). The electronic work function 12 may be a stand-alone software application or form a part of a software application that carries out additional tasks related to the electronic device 10.

The electronic device 10 may include a display 22. The display 22 displays information to a user such as operating state, time, telephone numbers, contact information, various menus, etc., that enable the user to utilize the various features of the electronic device 10. The display 22 also may be used to visually display content to a user, such as photographs, mobile television content, Internet pages, and video. In addition, the text from the text version 18 of the electronic work 16 may be displayed on the display 22.

The electronic device 10 may include one or more user inputs. For example, a keypad 24 may include alphanumeric keys for allowing entry of alphanumeric information (e.g., telephone numbers, phone lists, contact information, notes, text, etc.) and/or special function keys (e.g., a select key, a call send and answer key, multimedia playback control keys, a camera shutter button, etc.). A navigation or pointing device 26 also may be present. In addition to keys or instead of keys, input functionality may be embodied as a touch screen associated with the display 22. Also, the display 22 and keypad 24 may be used in conjunction with one another to implement soft key functionality.

The various user inputs may be employed by the user to input commands to the electronic device 10 for interaction with the displayed text from the text version 18. For example, the user may input a command to “turn” a displayed “page” of text, or scroll forward or backward through the displayed text.

The electronic device 10 includes communications circuitry that enables the electronic device 10 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., the electronic work 16, image files, video files, audio files, ring tones, Internet content, etc.), receiving or sending messages (e.g., text messages, instant messages, electronic mail messages, multimedia messages), and so forth. This data may be processed by the electronic device 10, including storing the data in the memory 20, executing applications to allow user interaction with the data, displaying video and/or image content associated with the data, outputting audio sounds associated with the data, and so forth.

In the exemplary embodiment, the communications circuitry may include an antenna 28 coupled to a radio circuit 30. The radio circuit 30 includes a radio frequency transmitter and receiver for transmitting and receiving signals via the antenna 22.

The radio circuit 30 may be configured to interact with a communications network 32. Radio circuit 30 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 28 and the radio circuit 30 may represent one or more than one radio transceiver.

The communications network 32 may include a server 34 (or servers) for managing calls placed by and destined to the electronic device 10, transmitting data to and receiving data from the electronic device 10, and carrying out any other support functions. The server 34 communicates with the electronic device 10 via a transmission medium. The transmission medium may be any appropriate device or assembly, including, for example, a communications base station (e.g., a cellular service tower, or “cell” tower), a wireless access point, a satellite, etc. The network 32 may support the communications activity of multiple electronic devices 10 and other types of end user devices. In alternative arrangements, the electronic device 10 may wirelessly communicate directly with another electronic device 10 (e.g., another mobile telephone or a computer) through a local network or without an intervening network.

The electronic device 10 may include a primary control circuit 36 that is configured to carry out overall control of the functions and operations of the electronic device 10. The control circuit 36 may include a processing device 38, such as a central processing unit (CPU), microcontroller or microprocessor. The processing device 38 executes code stored in a memory (not shown) within the control circuit 36 and/or in a separate memory, such as the memory 20, in order to carry out operation of the electronic device 10. For instance, the memory within the control circuit 36 and/or the memory 20 may store executable code that embodies the electronic work function 12 and the processing device 38 may execute that code so that the control circuit 36 is configured to implement the functions of the electronic work function 12. The memory 20 and/or any memory of the control circuit 36 may include one or more types of memory components. For example, memory of the electronic device 10 may be one or more of a buffer, a flash memory, a hard drive, a removable media, a volatile memory, a non-volatile memory, a random access memory (RAM), or other suitable device. In one arrangement, the memory 20 may include a non-volatile memory for long term data storage and a volatile memory that functions as system memory for the control circuit 36. The memory 20 may exchange data with the control circuit 36 over a data bus. Accompanying control lines and an address bus between the memory 20 and the control circuit 36 also may be present.

The electronic device 10 further includes a sound signal processing circuit 40 for processing audio signals. Coupled to the sound processing circuit 40 are a speaker 42 and a microphone 44 that enable a user to listen and speak via the electronic device 10 during a call. Audio corresponding to music files, video files, the audio version 14 of the electronic work 16 and other audio sources also may be output via the speaker 42. Audio data may be passed from the control circuit 36 to the sound signal processing circuit 40 for playback to the user. Similarly, audio signals generated by the microphone 44 may be input to the sound signal processing circuit 40. The sound signal processing circuit 40 may include any appropriate buffers, decoders, encoders, amplifiers and so forth.

The display 22 may be coupled to the control circuit 36 by a video processing circuit 46 that converts video data to a video signal used to drive the display 22. The video processing circuit 46 may include any appropriate buffers, decoders, video data processors and so forth.

The electronic device 10 may further include one or more input/output (I/O) interface(s) 48. The I/O interface(s) 48 may be in the form of typical mobile telephone I/O interfaces and may include one or more electrical connectors for serving as data ports that connect the electronic device 10 to another device (e.g., a computer) or an accessory (e.g., a personal handsfree (PHF) device) via a cable. Further, operating power may be received over the I/O interface(s) 48 and power to charge a battery of a power supply unit (PSU) 50 within the electronic device 10 may be received over the I/O interface(s) 48. The PSU 50 may supply power to operate the electronic device 10 in the absence of an external power source.

The electronic device 10 also may include various other components. A forward facing camera 52 may be present for taking digital pictures and/or movies. In a camera mode, the display 22 may function as an electronic viewfinder. Image and/or video files corresponding to the pictures and/or movies may be stored in the memory 20. A position data receiver 54, such as a global positioning system (GPS) receiver, may be involved in determining the location of the electronic device 10. A local transceiver 56, such as an RF transceiver (e.g., a Bluetooth chipset) may be used to establish communication with a nearby device, such as an accessory (e.g., a wireless PHF device), another mobile radio terminal, a computer or another device.

The electronic device 10 may further include a rearward facing camera 58 that is arranged to capture pictures and/or video of the user. An exemplary application for the camera 58 is to enable video telephony. As will be described in greater detail, the camera 58 may be used while the user reads the text version 18 of the electronic work 16. For instance, a video signal generated by the camera 58 may be analyzed to assess eye gaze of the user. Assessing eye gaze may include tracking eye movement. The eye gaze, in turn, may be correlated against the displayed text to identify the user's position in the text. The user's position in the text (or user's text position) may be the point in the work up to which the user has read. The user's position may be measured with respect to a word, a sentence or a paragraph depending on the accuracy and sophistication of the eye gaze analysis.

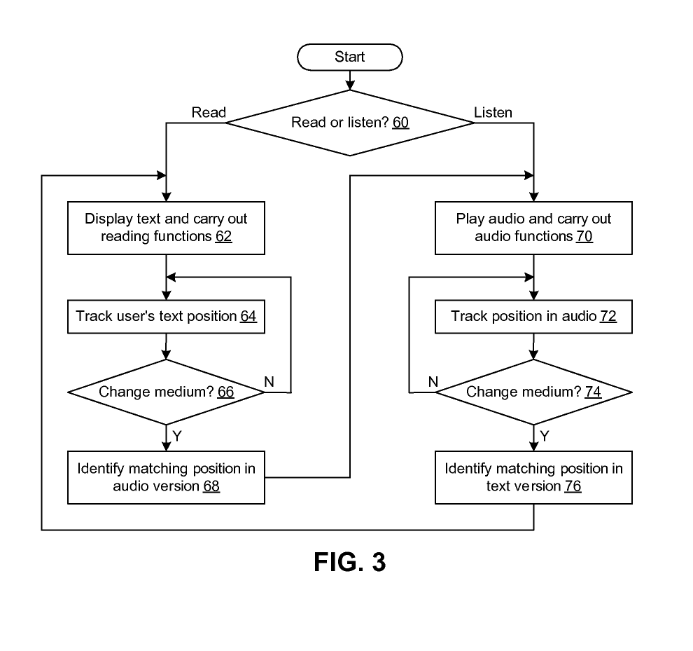

With additional reference to FIG. 3, illustrated are logical operations to implement an exemplary method of presenting written material to a user including switching between a readable text form of the written material and an audible form of the written material. It will be appreciated that the described embodiment of switching between forms of the written material is exemplary, and the described techniques may be applied to any two or more types of media.

The exemplary method may be carried out by executing an embodiment of the electronic work function 12, for example. Thus, the flow chart of FIG. 3 may be thought of as depicting steps of a method carried out by the electronic device 10. Although FIG. 3 shows a specific order of executing functional logic blocks, the order of executing the blocks may be changed relative to the order shown. For instance, the below described text position tracking operation and the corresponding audio position matching operation each may be carried out prior to the medium change determination. Also, two or more blocks shown in succession may be executed concurrently or with partial concurrence. Certain blocks also may be omitted.

The logical flow may begin in block 60 where a determination is made as to whether the user desires to read the text version 18 of the electronic work 16 or listen to the audio version 14 of the electronic work 16. The user may specify the version through a menu selection or other type of selection presented as part of a displayed graphical user interface (GUI).

Upon a determination that the user has selected to read the text version 18, the logical flow may proceed to block 62. In block 62, text from the text version 18 may be displayed. If the user had previously read or listened to some of the electronic work 16, the displayed text may start at a point in the text where the user last stopped reading or listening to the electronic work 16. Otherwise, the display of text may start from the beginning of the electronic work 16. Techniques for tracking the user's place in the electronic work 16 will be described in greater below.

In addition, various reading functions may be carried out. Reading functions may include advancing through text as the user reads, such as by scrolling or moving ahead by a block of text in a manner that mimics turning the page of a physical book. Advancing through the text in this manner may be responsive to a user input command or responsive to a determination that the user's eyes are directed toward text that appears at or near a bottom of the display 22. Other functions may include back-tracking through the text or skipping ahead in the text. In one embodiment, the audio version 14 may be played as the user reads the text version 18. Eye gaze analysis may be used to match the pace of playback with the pace of reading.

In block 64, the user's text position in the text version 18 may be tracked. As indicated, the user's text position may be tracked using eye gaze analysis. In other embodiments, the user's text position may be ascertained by the displayed text. For example, the user's text position may be deemed to be the text appearing at the top of the display 22. In other embodiments, the user may manually indicate the user's text position.

In block 66, a determination may be made as to whether the user has entered a user input to command a change in the manner that the electronic work 16 is presented to the user. More specifically, the user may use a menu item or GUI button to change from reading the text version 18 to playing the audio version 14. If a negative determination is made in block 66, the reading mode may continue. If a positive determination is made in block 66, the logical flow may proceed to block 68.

In block 68, a position in the content of the audio version 14 that matches the user's current text position may be identified. In one embodiment, the audio version 14 may be converted to text by speech to text software and a search for words at the user's current text position may be made. In another embodiment, the text version 18 and the audio version 14 may include corresponding markers (e.g., bookmarks or data tags) embedded in the corresponding data structures. For instance, each sentence or paragraph in the text version 18 may have a unique marker. The corresponding spoken text in audio version 14 may be appended with the same markers. The electronic work function 12 may match a marker's value that corresponds to the user's current position in one version with the same marker value in the other version. In this manner, the electronic work function 12 may identify the user's position in one version relative to the other version with a relatively high degree of precision (e.g., within a sentence or a paragraph of where the user stopped reading or listening).

Following block 68 or following a determination that the user has selected to listen to the audio version 14 in block 60, the logical flow may proceed to block 70. In block 72, audio from the audio version 14 may be output from the speaker 42 or an operatively interfaced output device, such as a PHF. If the user had previously read or listened to some of the electronic work 16, the audio may start at a point in the text where the user last stopped reading or listening to the electronic work 16. Otherwise, the output of audio may start from the beginning of the electronic work 16.

In addition, various audio playback functions may be carried out. Playback functions may include, for example, stopping, starting, pausing, fast-forwarding and rewinding the audio playback. These operations may be controlled by the user using typical audio playback controls.

In block 72, the playback position in the audio version 14 may be tracked. The playback position may be tracked using, for example, the above-mentioned markers or a playback timer that indicates how many minutes and seconds are present between the beginning (or end) of the audio version 14 and the current position.

In block 74, a determination may be made as to whether the user has entered a user input to command a change in the manner that the electronic work 16 is presented to the user. More specifically, the user may use a menu item or GUI button to change from playing the audio version 14 to reading the text version 18. If a negative determination is made in block 74, the listening mode may continue. If a positive determination is made in block 74, the logical flow may proceed to block 76.

In block 76, a position in the content of the text version 18 that matches the user's current audio version position may be identified. In one embodiment, the audio version 14 may be converted to text by speech to text software and a search for words at the current audio position may be made. In another embodiment, the above-described markers may be used to identify the matching position.

Following block 76, the logical flow may proceed to block 62 where text from the text version 18 is displayed starting at a position that corresponds to the audio position when the user choose to switch output mediums.

The foregoing technique of delivering written material to a user may provide a convenient and fulfilling experience to the user. For example, a user may ride a train to work and, during the ride, read the text version 18. After departing the train, the user may have a walk from the train station to his or her office. During that time, the user may listen to the audio version 14. Using techniques that are described above, minimal action by the user may be needed to ascertain and track the user's position in the written material. Therefore, switching between reading and listening may be simple and intuitive for the user. In some embodiments, the switch may be made simply by using a single user input, such as pressing a “change to reading” button while in listening mode or pressing a “change to listening” button while in reading mode.

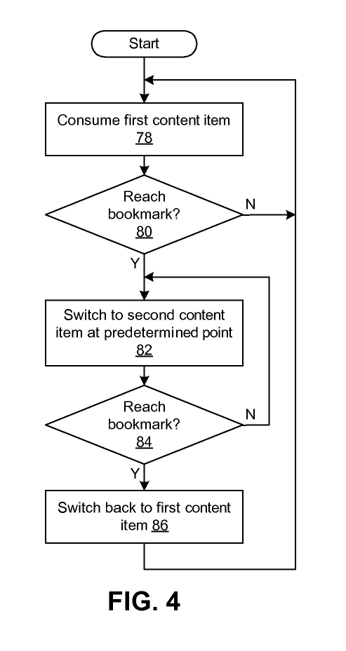

With additional reference to FIG. 4, illustrated are logical operations to implement another exemplary method of presenting media to a user including switching between a first content item and a second content item. For purposes of description, an exemplary first content item may be a document and a second content item may be a video, but it will be appreciated that any type of media may be substituted for one or both of these content items.

The exemplary method may be carried out by executing an embodiment of the electronic work function 12, for example. Thus, the flow chart of FIG. 4 may be thought of as depicting steps of a method carried out by the electronic device 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted.

The logical flow may begin in block 78 where a user consumes the first content item. In the example where the first content item is a document, the content may be consumed by reading the text of the document on the display 22, such as with an electronic book reader, a word processing program, or other appropriate program. Then, in block 80, a determination may be made as to whether the user has reached a bookmark in the first content item. The bookmark may be positioned at a predetermined point in the first content item. Reaching the bookmark, therefore, may be determined using any appropriate user position tracking mechanism, including one of the tracking mechanisms described above. If a negative determination is made in block 80, the user may continue to consume the first content item. If a positive determination is made in block 80, the logical flow may proceed to block 82.

In block 82, the electronic device may present the second content item. In the example where the second content item is a video, the content may be consumed by displaying the video on the display 22, such as with a media or video player. Audio associated with the video also may be output. In an example where the second content item is an Internet web page, content from the Internet web page may be output by a web browser.

The presentation of the second content item may begin at a predetermined point in the second content item that corresponds to the bookmark that was reached in the first content item. In one embodiment, the starting point in the second content may be marked with a starting bookmark that corresponds to the bookmark that was reached in the first content item.

Then, in block 84, a determination may be made as to whether the user has reached an ending bookmark in the second content item. The ending bookmark may be positioned at a predetermined point in the second content item. Reaching the ending bookmark, therefore, may be determined using any appropriate user position tracking mechanism, including one of the tracking mechanisms described above. If a negative determination is made in block 84, the user may continue to consume the second content item. If a positive determination is made in block 84, the logical flow may proceed to block 86.

In block 86, the electronic device may return to presentation of the first content item. The return to presentation of the first content item may begin at a predetermined point in the first content item that corresponds to the ending bookmark in the second content item. In one embodiment, this restarting point in the first content may be marked with a bookmark that corresponds to the ending bookmark in the second content item.

Although certain embodiments have been shown and described, it is understood that equivalents and modifications falling within the scope of the appended claims will occur to others who are skilled in the art upon the reading and understanding of this specification.

What is claimed is:

1. An electronic device that has access to a first content item and a second content item, comprising:
at least one output for outputting content from the first and second content items to a user; and
a processor configured to:
output content from the first content item;
identify when user consumption of the first content item has reached a predetermined point in the first content item; and
in response to the identification, switch to output content from the second content item starting at a predetermined point in the second content that is associated with the predetermined point in the first content item.

2. The electronic device of claim 1, wherein each of the first and second content items are one of text, audio, video or an Internet web page.

3. The electronic device of claim 1, wherein the predetermined point in the first content item and the predetermined point in the second content are marked with corresponding bookmarks.

4. An electronic device, comprising:
a memory that stores an electronic work containing a text version of written material and an audio version of the written material;
a display configured to display text from the text version in a reading mode;
an audio output configured to output an audio signal corresponding to the audio version in a listening mode; and
a processor configured to:
in the reading mode, identify a user text position in the text version and, responsive to a user input to switch to the listening mode, switch to the listening mode and playback the audio version from a point that corresponds to the user text position; and
in the listening mode, identify an audio playback position in the audio version and, responsive to a user input to switch to the reading mode, switch to the reading mode and display the text version from a point that corresponds to the audio playback position.

5. The electronic device of claim 4, wherein the audio output is one of a speaker, an input/output interface that is operatively connected to an accessory device having a speaker, or a wireless transceiver that is operatively connected to a wireless accessory device having a speaker.

6. The electronic device of claim 4, further comprising a camera configured to capture video data of the user during the reading mode and the processor further configured to analyze user eye gaze to identify the user text position.

7. The electronic device of claim 4, wherein a portion of displayed text is used for the user text position.

8. The electronic device of claim 4, wherein the processor converts at least a portion of the audio version to text, extracts text from the audio playback position, and searches the text version for corresponding text to identify the point in the text version that corresponds to the audio playback position.

9. The electronic device of claim 4, wherein the processor converts at least a portion of the audio version to text and searches the converted text for text that corresponds to text at the a user text position to identify the point in the audio version that corresponds to the user text position.

10. The electronic device of claim 4, wherein the text version and the audio version contain corresponding data markers used by the processor to identify the corresponding positions in the text and audio versions of the electronic work.

11. A method of outputting written material to a user of an electronic device, comprising:
storing an electronic work in a memory, the electronic work containing a text version of written material and an audio version of the written material;
in a reading mode of the electronic device:
displaying text from the text version;
identifying a user text position in the text version; and
responsive to a user input to switch to a listening mode, switching to the listening mode and playing back the audio version from a point that corresponds to the user text position; and
in the listening mode:
playing back the audio version;
identifying an audio playback position in the audio version; and
responsive to a user input to switch to the reading mode, switching to the reading mode and displaying the text version from a point that corresponds to the audio playback position.

12. The method of claim 11, further comprising capturing video data of the user during the reading mode and analyzing user eye gaze to identify the user text position.

13. The method of claim 11, wherein a portion of displayed text is used for the user text position.

14. The method of claim 11, further comprising converting at least a portion of the audio version to text, extracting text from the audio playback position, and searching the text version for corresponding text to identify the point in the text version that corresponds to the audio playback position.

15. The method of claim 11, further comprising converting at least a portion of the audio version to text and searching the converted text for text that corresponds to text at the a user text position to identify the point in the audio version that corresponds to the user text position.

16. The method of claim 11, wherein the text version and the audio version contain corresponding data markers used in the identifying of the corresponding positions in the text and audio version of the electronic work.

17. A computer readable medium, comprising:
a first content item;
a second content item;
a first bookmark at a predetermined position in the first content item, the bookmark indicating to an electronic work function to switch from output of content from the first content item to output of content from the second content item; and
a second bookmark at a predetermined position in the second content item, the second bookmark corresponding to the first bookmark and representing a predetermined starting point in the second content item at which the output of content from the second content item is to commence when user consumption of the first content item has reached the first bookmark.

18. The computer readable medium of claim 17, wherein each of the first and second content items are one of text, audio, video or an Internet web page.

19. A computer readable medium storing an electronic work, comprising:
a text version of written material;
an audio version of the written material;
position data markers in the text version; and
position data markers in the audio version, each position data marker in the audio version corresponding to a data marker in the text version to identify corresponding positions in the text and audio versions of the electronic work.
